(19) United States
(12) Patent Application Publication
(10) Pub. No.: US 2016/0349511 A1
(43) Pub. Date: Dec. 1, 2016

(54) SEE-THROUGH BINOCULAR HEAD MOUNTED DEVICE

(71) Applicant: Fieldbit LTD., Kfar-Saba (IL)

(72) Inventors: Evyatar Meiron, Kfar-Saba (IL); Shay Solomon, Kfar-Saba (IL); Alex Rapoport, Tel-Aviv (IL)

(21) Appl. No.: 14/726,542

(22) Filed: May 31, 2015

(51) Int. Cl. G02B 27/01; G06T 1/00; G06T 3/40; G06F 3/01

(52) U.S. Cl. CPC G02B 27/0172; G06F 3/011; G06T 1/0007; G06T 3/40; G06T 3/4092; G02B 2027/0132; G02B 2027/014; G02B 2027/0138; G02B 2027/0147

(57) ABSTRACT

A method for providing augmented reality, the method may include performing a calibration process based upon (i) at least a first image of an object and (ii) feedback from a wearer of the see-through binocular head mounted display (STBHMD) device; receiving an input augmented image of the object; wherein the input augmented image of the object comprises a certain image of the object and input digital content that refers to a certain element of the object; calculating, in response to an outcome of the calibration process, output digital content that refers to a visual representation of the certain element of the object in second images of the object; and displaying the output digital content on the display of the STBHMD thereby forming output augmented images of the object.

### BACKGROUND

Various people such as field technicians may benefit from receiving guidance from other people. The efficiency of this guidance may dramatically decrease when it refers to one or more element of an object that includes multiple elements. For example, when maintaining a machine that has numerous control buttons it may be hard to identify the exact control button that should be pressed.

There is a growing need to provide targeted guidance to persons.

### SUMMARY

There are provided systems, methods and non-transitory computer readable media, as illustrated in the claims.

According to an embodiment of the invention there may be provided a method for providing augmented reality, the method may include performing a calibration process based upon (i) at least a first image of an object and (ii) feedback from a wearer of a see-through binocular head mounted display (STBHMD) device; receiving an input augmented image of the object; wherein the input augmented image of the object comprises a certain image of the object and input digital content that refers to a certain element of the object; calculating, in response to an outcome of the calibration process, output digital content that refers to a visual representation of the certain element of the object in second images of the object; and displaying the output digital content on the display of the STBHMD thereby forming output augmented images of the object.

The first image of the object may be acquired by the STBHMD device.

The first image of the object may be acquired by a device that differs from the STBHMD device.

The certain image of the object may be acquired by the STBHMD device.

The certain image of the object may be acquired by a device that differs from the STBHMD device.

The calculating of the output digital content may be responsive to a relationship between the certain image of the object and the second images of the object.

The performing of the calibration process comprises (i) displaying, on a display of the STBHMD device, and at different point in time of the calibration process, partially transparent representations of the first image of the object, and (ii) receiving the feedback from the wearer of the STBHMD device.

The method may include changing, in response to the feedback from the wearer of the STBHMD device, at least one parameter of a current partially transparent representation of the first image of the object to provide a next partially transparent representation of the first image; and wherein the current and next partially transparent representation of the first image belong to the partially transparent representations of the first image of the object.

The at least one parameter may be a scale of the partially transparent representation of the first image.

The method comprising changing resolution of the scale.

The certain image of the object belongs to the at least first image of the object acquired during the calibration process.

The certain image of the object does not belong to the at least first image of the object acquired during the calibration process.

According to an embodiment of the invention there may be provided a non-transitory computer readable medium that stores instructions that once executed by a see-through binocular head mounted display (STBHMD) device cause the STBHMD device to execute the steps of: performing a calibration process based upon (i) at least a first image of an object and (ii) feedback from a wearer of the STBHMD device; receiving an input augmented image of the object; wherein the input augmented image of the object comprises a certain image of the object and input digital content that refers to a certain element of the object; calculating, in response to an outcome of the calibration process, output digital content that refers to a visual representation of the certain element of the object in second images of the object; and displaying the output digital content on the display of the STBHMD thereby forming output augmented images of the object.

According to an embodiment of the invention there may be provided a see-through binocular head mounted display (STBHMD) device that comprises a camera, a display, a projector, a processor and a sensor; wherein the sensor may be configured to sense, during a calibration process, from a wearer of the STBHMD device; wherein the processor may be configured to calculate a calibration process result in response to feedback, and at least a first image of an object; wherein the STBHMD device may be configured to receive an input augmented image of the object; wherein the input augmented image of the object comprises a certain image of the object and input digital content that refers to a certain element of the object; wherein the processor may be configured to calculate, in response to an outcome of the calibration process, output digital content that refers to a visual representation of the certain element of the object in second images of the object; and wherein the projector may be configured to project on the display the output digital content thereby forming output augmented images of the object.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a system according to an embodiment of the invention;

FIG. 2 an partially transparent representation of an image of an object that is overlaid over an image of the object as seen through a display of a see-through binocular head mounted display (STBHMD) device according to an embodiment of the invention;

FIG. 3 illustrates a system according to an embodiment of the invention;

FIG. 4 illustrates various aspects of a calibration process;

FIG. 5 illustrates a method according to an embodiment of the invention;

FIG. 6 illustrates an input augmented image according to an embodiment of the invention; and

FIG. 7 illustrates an output augmented image according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

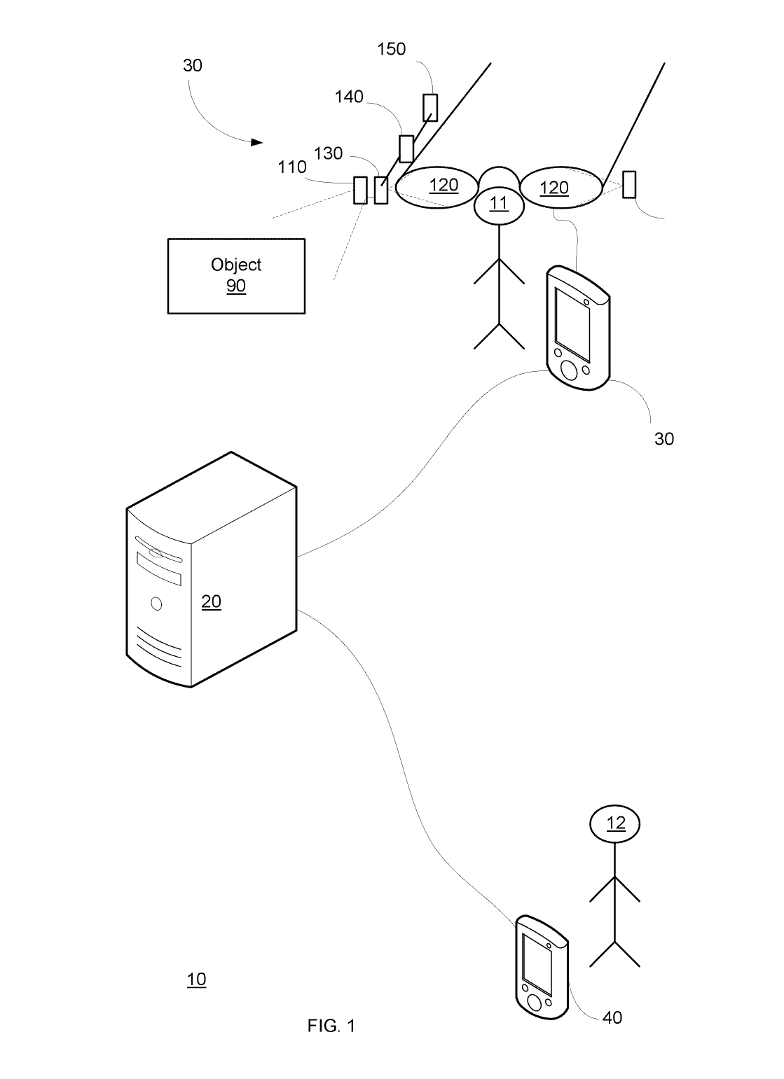

FIG. 1 illustrates a system 10 according to an embodiment of the invention.

System 10 includes first device 30 of a first person 11, second device 40 of a second person 12, a see-through binocular head mounted display (STBHMD) device 100 worn by the first person, and a remote computer such as a cloud server 20. FIG. 1 is out of scale.

STBHMD device 100 may be shaped as wearable glasses.

Cloud server 20, first device 30, second device 40 and STBHMD device 100 may be coupled to each other over one or more networks.

Cloud server 20 can store at least part of the traffic exchanged between the first and second devices, relay the traffic between the first and second devices, and the like.

First device 30 and second device 40 may be mobile phones, personal data assistants, tablets or any other computerized system.

The first person may be a remote technician. The first person may request to receive guidance from the second person relating to a maintenance operation related to an object or any other operation related to the object.

The first device 30 may send, to the second device 40, a first image of the object. The first image may be acquired by STBHMD device 100 or by first device 30.

The second person may create digital content (referred to as input digital content) that may refer to a certain element of the object. The digital content may be fed to the second device 40 using any known method.

The input digital content may be one or more symbols, text and the like. For example—the input digital content may include a circle that surround the certain element of the object, an arrow pointing to the certain element of the object, and the like.

Second device 40 may overlay the input digital content onto an image of the object to provide an input augmented image of the object.

STBHMD device 100 may perform, with an assistance of the first person, a calibration process in order to determine the spatial relationship between STBHMD device 100 at a certain moment. The calibration process is significant because the optical axis of a camera of STBHMD device 100 is not aligned with the line of sight of the first person. It is noted that the calibration process may be skipped under certain circumstances. For example—when the dimensions of the object and/or one or more object elements are known and can be used for determining the spatial relationship to STBHMD system 100.

STBHMD device 100 may use the outcome of the calibration process in order to generate an output augmented image of the object in which an output digital content is properly overlaid on the certain element of the object—as viewed by the first person.

The calibration process may include multiple calibration iterations.

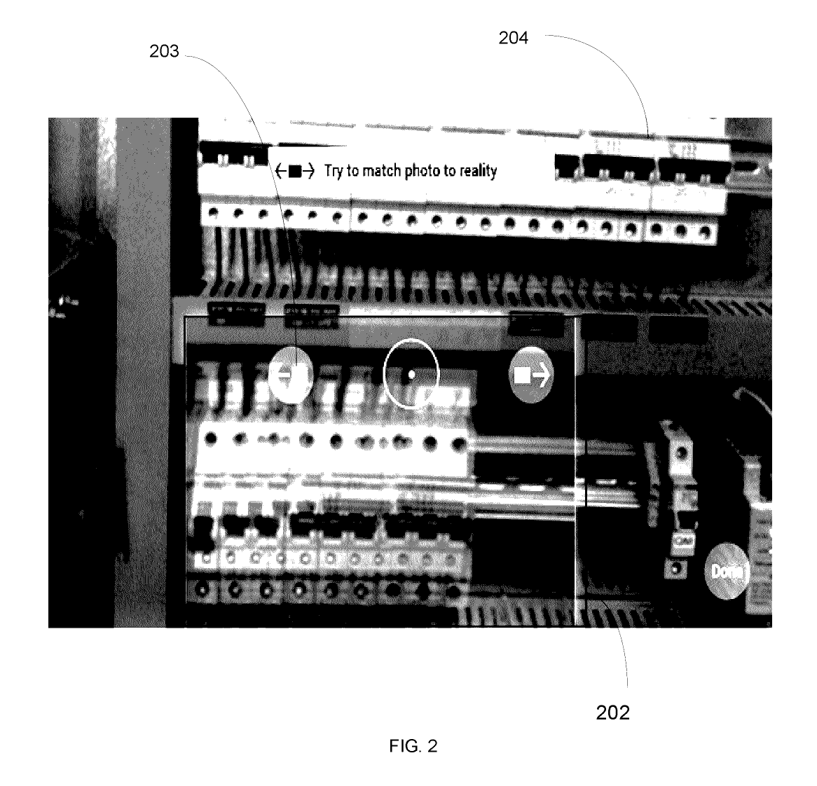

During each calibration iteration STBHMD device 100 displays a partially transparent representation of a first image of the object (hereinafter “partially transparent representation”) so that the first person sees the object itself and the partially transparent representation of the first image of the object—see for example FIG. 2 that illustrates a partially transparent representation 202 overlaid over object 204 as seen by the first person.

STBHMD device 100 then receives feedback from the first person relating to the alignment or misalignment between the object itself and the partially transparent representation.

STBHMD device 100 may, for example, display one or more control symbols (for example—a move right symbol, a move left symbol, a move up symbol, a move down symbol, an increase scale symbol, a decrease scale symbol, a calibration completion symbol, or any other control symbols) and allow the first person to elect one of these symbols by performing one or more head movements and/or one or more gestures for selecting one of the symbols. FIG. 2 illustrates an example of control symbol 203.

A symbol may be selected, for example by looking (by the first person) at the same direction for over a predefined period (for example—more than one second).

STBHMD device 100 may then determine whether the calibration process succeeded or whether to perform another calibration iteration. When determining to perform another calibration iteration then STBHMD device 100 changes at least one parameter of the partially transparent representation of the first image to provide a next partially transparent representation of the first image to be used during the next calibration iteration.

The feedback can include at least one out of a vocal instruction, a head movement, any movement within the field of view of STBHMD device 100, a contact between the first person and STBHMD device 100 (pressing a control button), and the like.

Once the calibration process ends, STBHMD device 100 may determine the spatial relationship between STBHMD device 100 and the object.

The spatial relationship may be fed to a tracking module of STBHMD device 100 that tracks the movements of STBHMD device 100 in order to properly overlay the output digital content on any image of the object.

FIG. 1 illustrates STBHMD device 100 as including camera 110, display 120, projector 130, processor 140 and a sensor 150.

Camera 110 may acquire images. Display 120 is a see-through display. Projector 130 may project digital content onto display 120. Processor 140 may determine the manner in which the digital content is projected on display 120. Processor 140 may perform motion tracking.

Sensor 150 may be an accelerometer, a gyroscope or any other sensor that may sense movements of the head of the first person. Sensor 150 may be a voice sensor capable of detecting (with or without the help of processor 140) voice commands. Alternatively, sensor 150 may be the camera 110 wherein processor 140 may detect head movements and/or gestures made within the field of view of camera 110.

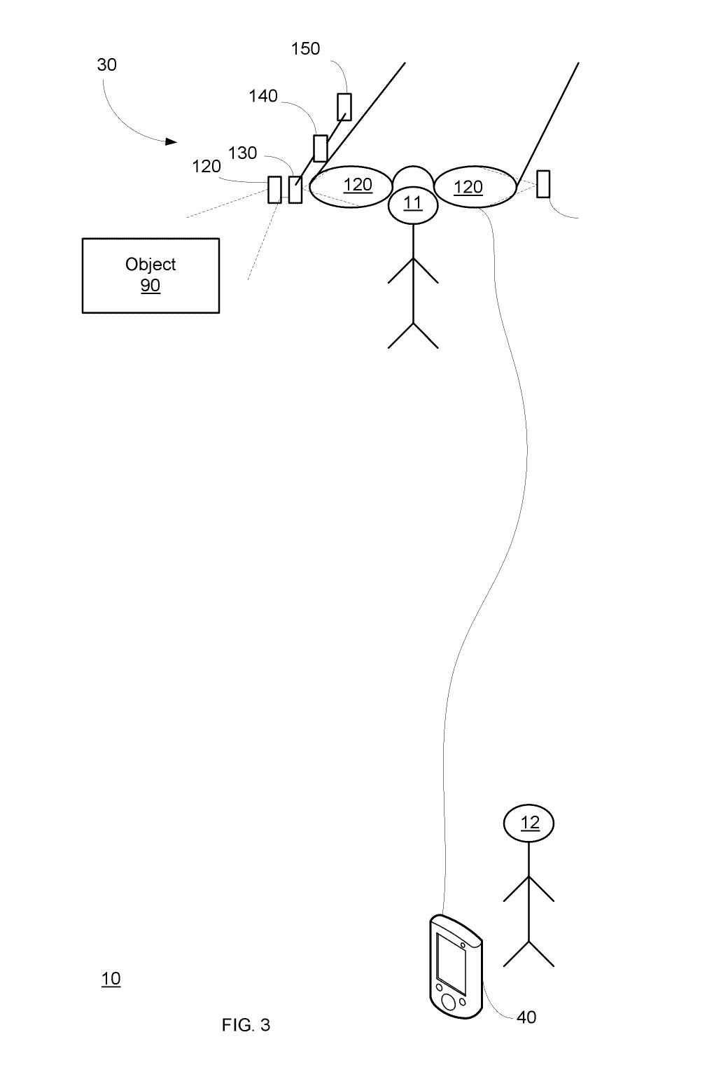

FIG. 3 illustrates a system 10 according to an embodiment of the invention.

System 10 includes second device 40, STBHMD device 100 and one or more networks (not shown).

In system 10 of FIG. 3 STBHMD device 100 communicates with second device 40 without the assistance of a cloud server.

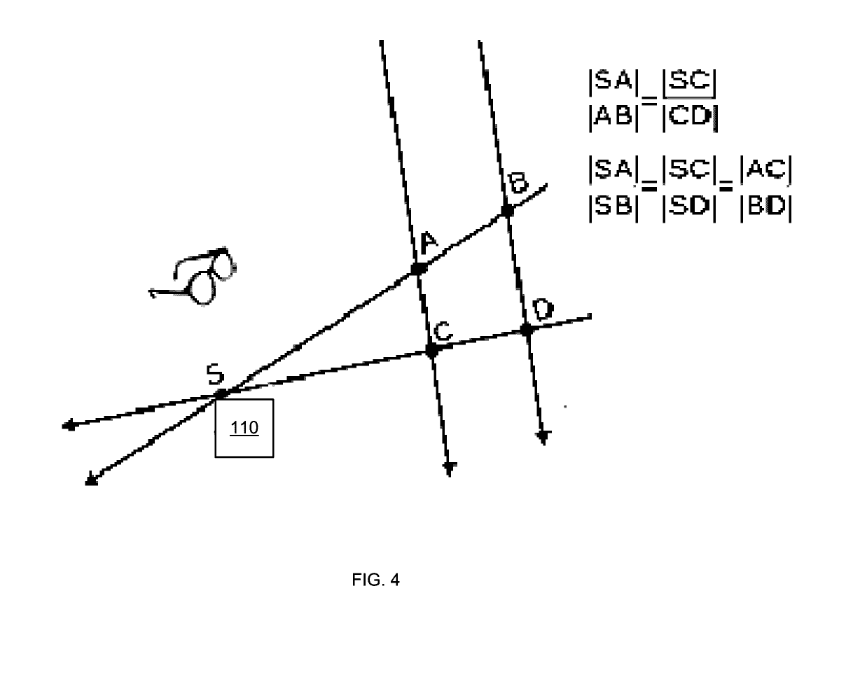

FIG. 4 illustrates various aspects of a calibration process.

The calibration process assists in achieving spatial relationship information that may allow accurate augmentation of digital information over an image located at unknown distance or having unknown dimensions.

The calibration process may be based upon the intercept theory. in elementary geometry about the ratios of various line segments that are created if two intersecting lines are intercepted by a pair of parallels, as can be seen in the FIG. 3.

FIG. 4 illustrates a location (represented by point S) of STBHMD device 100, a location of an object (represented by points S and D) and an initial estimated location of the object (represented by points A and C).

According to the theorem, there is a fixed ratio between the distance from STBHMD device 100 (SC or SD) to the target width (AC or BD).

When the first person looks at the object, and the object is identified by STBHMD device 100, an partially transparent representation of a first image of the object is displayed to the user so the user can see both the real object and the partially transparent representation.

Because the initial estimated location of the object is erroneous the partially transparent representation and the object (as seen by the first person) are misaligned.

STBHMD device 100 performs, using feedback from the first person, a calibration process and once the user approves that an alignment is obtained—STBHMD device 100 may assume that the distance between STBHMD device 100 and the object is known. The distance may be a length of an imaginary normal from point S to section DB.

According to an embodiment of the invention the calibration process may include setting the partially transparent representation to be of a predefined size (scale) and the user may change the size (scale). The scale may be changes by a scaling factor.

For example, STBHMD device 100 may scale the partially transparent representation of the first image to a fixed size (keep ratio), e.g. 640*480 pixels, assuming that each pixel represents a 1 mm square area. It is noted that the number of pixels may differ from 640*480 pixels.

STBHMD device 100 uses a metric of 1 px in the image is equal to 1 mm in reality. It is noted that the metric may differ from one pixel per millimeter.

STBHMD device 100 may start the calibration process using a predefined scale factor FACTOR (which sets the sensitivity/accuracy level of the alignment).

STBHMD device 100 then starts the multiple calibration iterations during which the feedback from the first person may require the partial transparent representation to move and/or to change its scale (thereby increasing or decreasing its size).

There is provides an example of a pseudo-code:

```
WIDTH_MM = 640
HEIGHT_MM = 480
FACTOR = 0.1
MAX = 10 #6.4 Meter
MIN = 0.1 #6.4 cm
K = 1
Annotation_init(IMAGE,K)
Start_track(IMAGE, WIDTH_MM, HEIGHT_MM)
while (TRUE)
  if (scaling_input_arrived)
      if (scale_up and K < MAX) // received from user head movement
            K = K + FACTOR
      else if (scale_down and K > MIN) //scale_down
            K = K − FACTOR
      restart_tracking(IMAGE, WIDTH_MM*K, HEIGHT_MM*K)
      Annotation_Rescale(K)
```

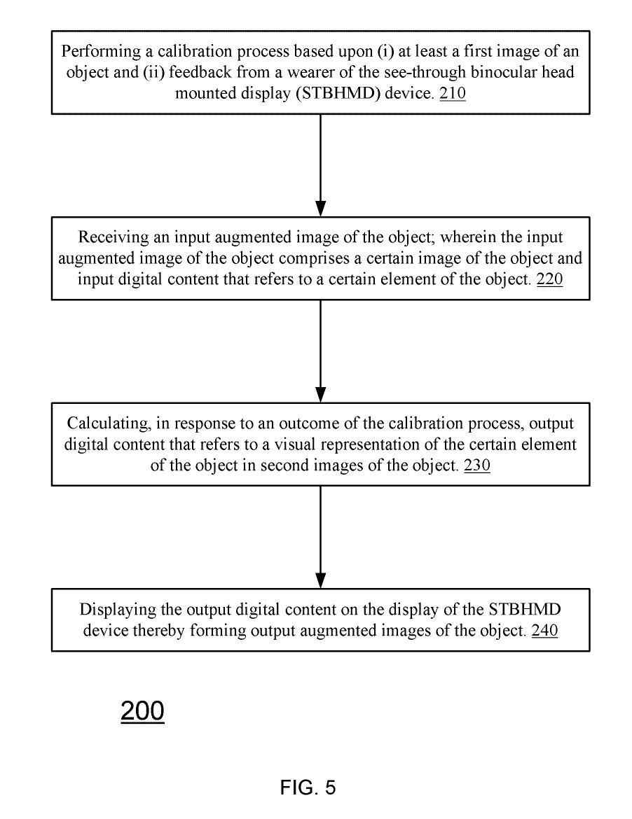

FIG. 5 illustrates method 200 for providing augmented reality, according to an embodiment of the invention.

Method 200 may start by stage 210 of performing a calibration process based upon (i) at least a first image of an object and (ii) feedback from a wearer of the see-through binocular head mounted display (STBHMD) device.

The first image of the object may be acquired by the STBHMD device or by another device—such as first device 30 of FIG. 1.

Stage 210 may include performing multiple calibration iterations.

Each calibration iteration may include (i) displaying, on a display of the STBHMD device, and at different point in time of the calibration process, partially transparent representations of the first image of the object, (ii) receiving the feedback from the wearer of the STBHMD device; (iii) changing, in response to the feedback from the wearer of the STBHMD device, at least one parameter of a current partially transparent representation of the first image of the object to provide a next partially transparent representation of the first image.

The at least one parameter may be a scale of the partially transparent representation of the first image. Method 200 may include changing the resolution of the scale.

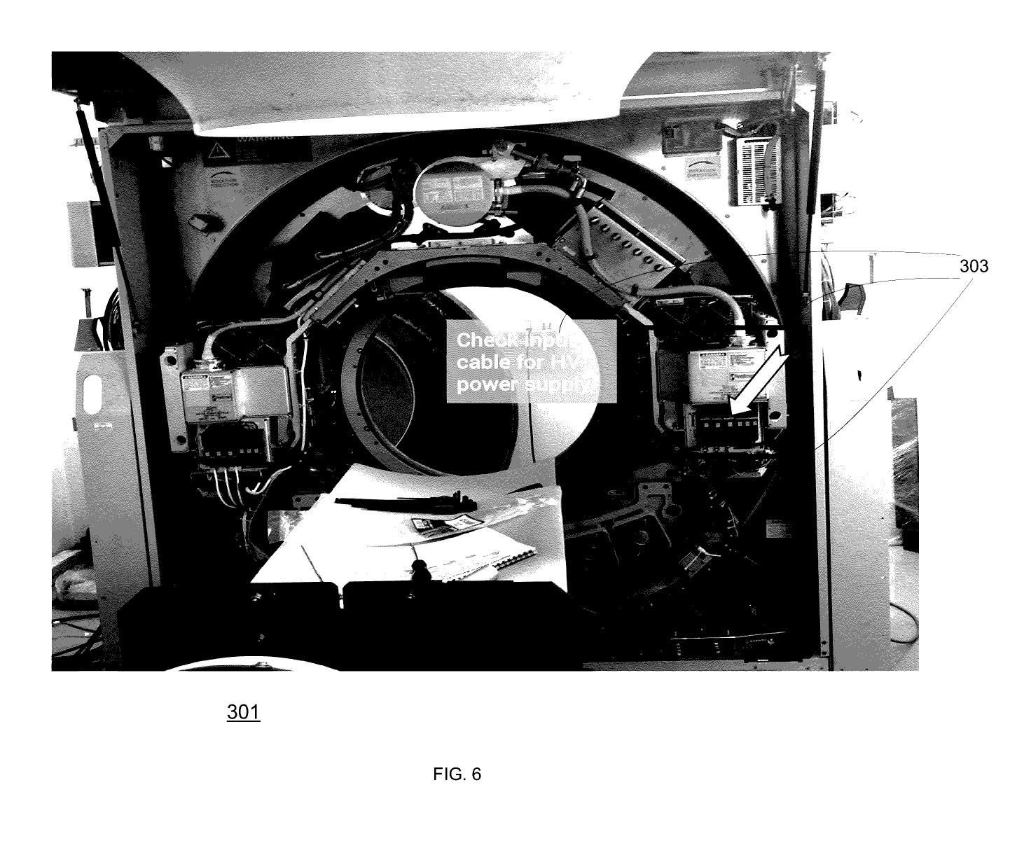

Stage 210 may be followed by stage 220 of receiving an input augmented image of the object; wherein the input augmented image of the object comprises a certain image of the object and input digital content that refers to a certain element of the object. FIG. 6 illustrates an example of an input augmented image 301 that includes input digital content 303.

The certain image of the object may be acquired by the STBHMD device or by another device—such as first device 30 of FIG. 1. The certain image of the object may be acquired during the calibration process or outside the calibration process.

Stage 220 may be followed by stage 230 of calculating, in response to an outcome of the calibration process, output digital content that refers to a visual representation of the certain element of the object in second images of the object.

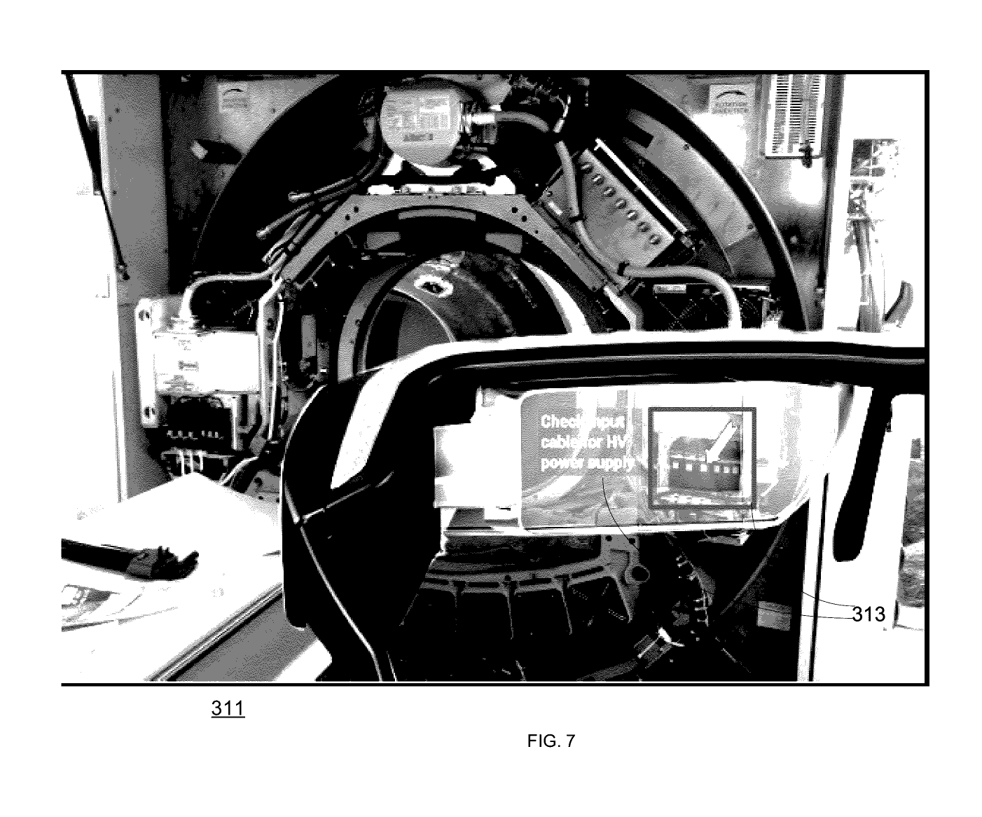

Stage 230 may be followed by stage 240 of displaying the output digital content on the display of the STBHMD device thereby forming output augmented images of the object. FIG. 7 illustrates an example of an output augmented image 311 that includes output digital content 313.

Stage 230 may be responsive to a relationship between the certain image of the object and the second images of the object. For example—a tracking unit may determine changes in the distance between the STBHMD device and the object and/or changes in a direction of image acquisition associated with the certain image of the object and the second images.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for providing augmented reality, the method comprises:
performing a calibration process based upon (i) at least a first image of an object and (ii) feedback from a wearer of a see-through binocular head mounted display (STBHMD) device;
receiving an input augmented image of the object; wherein the input augmented image of the object comprises a certain image of the object and input digital content that refers to a certain element of the object;
calculating, in response to an outcome of the calibration process, output digital content that refers to a visual representation of the certain element of the object in second images of the object; and
displaying the output digital content on the display of the STBHMD thereby forming output augmented images of the object.

2. The method according to claim 1 wherein the first image of the object is acquired by the STBHMD device.

3. The method according to claim 1 wherein the first image of the object is acquired by a device that differs from the STBHMD device.

4. The method according to claim 1 wherein the certain image of the object is acquired by the STBHMD device.

5. The method according to claim 1 wherein the certain image of the object is acquired by a device that differs from the STBHMD device.

6. The method according to claim 1, wherein the calculating of the output digital content is responsive to a relationship between the certain image of the object and the second images of the object.

7. The method according to claim 1, wherein the performing of the calibration process comprises (i) displaying, on a display of the STBHMD device, and at different point in time of the calibration process, partially transparent representations of the first image of the object, and (ii) receiving the feedback from the wearer of the STBHMD device.

8. The method according to claim 7, comprising changing, in response to the feedback from the wearer of the STBHMD device, at least one parameter of a current partially transparent representation of the first image of the object to provide a next partially transparent representation of the first image; and
wherein the current and next partially transparent representation of the first image belong to the partially transparent representations of the first image of the object.

9. The method according to claim 7, wherein the at least one parameter is a scale of the partially transparent representation of the first image.

10. The method according to claim 9, comprising changing resolution of the scale.

11. The method according to claim 1, wherein the certain image of the object belongs to the at least first image of the object acquired during the calibration process.

12. The method according to claim 1, wherein the certain image of the object does not belongs to the at least first image of the object acquired during the calibration process.

13. A non-transitory computer readable medium that stores instructions that once executed by a see-through binocular head mounted display (STBHMD) device cause the STBHMD device to execute the steps of: performing a calibration process based upon (i) at least a first image of an object and (ii) feedback from a wearer of the STBHMD device; receiving an input augmented image of the object; wherein the input augmented image of the object comprises a certain image of the object and input digital content that refers to a certain element of the object; calculating, in response to an outcome of the calibration process, output digital content that refers to a visual representation of the certain element of the object in second images of the object; and displaying the output digital content on the display of the STBHMD thereby forming output augmented images of the object.

14. A see-through binocular head mounted display (STBHMD) device that comprises a camera, a display, a projector, a processor and a sensor;
wherein the sensor is configured to sense, during a calibration process, from a wearer of the STBHMD device;
wherein the processor is configured to calculate a calibration process result in response to feedback, and at least a first image of an object;
wherein the STBHMD device is configured to receive an input augmented image of the object; wherein the input augmented image of the object comprises a certain image of the object and input digital content that refers to a certain element of the object;
wherein the processor is configured to calculate, in response to an outcome of the calibration process, output digital content that refers to a visual representation of the certain element of the object in second images of the object; and
wherein the projector is configured to project on the display the output digital content thereby forming output augmented images of the object.
